(19) United States
(12) Patent Application Publication
(10) Pub. No.: US 2025/0281895 A1
(43) Pub. Date: Sep. 11, 2025

(54) PLASMA REACTOR FOR GREENHOUSE GAS CONVERSION

(71) Applicant: UNIVERSITEIT ANTWERPEN, Antwerpen (BE)

(72) Inventors: Georgi TRENCHEV, Antwerpen (BE); Annemie BOGAERTS, Wommelgem (BE)

(21) Appl. No.: 18/862,599

(22) PCT Filed: May 8, 2023
(86) PCT No.: PCT/EP2023/062108

§ 371 Date: Nov. 4, 2024

(30) Foreign Application Priority Data
May 9, 2022 (EP) 22172411.5

(51) Int. Cl. B01J 19/08; B01J 19/00; C01B 3/34

(52) U.S. Cl. CPC B01J 19/088; B01J 19/0033; B01J 19/0073; C01B 3/342; B01J 2219/002; B01J 2219/00234; B01J 2219/0801; B01J 2219/0809; B01J 2219/0815; B01J 2219/082; B01J 2219/083; B01J 2219/0847; B01J 2219/0883; B01J 2219/0896; C01B 2203/0222; C01B 2203/0861

(57) ABSTRACT

The present disclosure relates to a plasma reactor for plasma-based gas conversion comprising a pin electrode extending along a longitudinal axis from a first end to a second end, an opposing electrode opposing a discharge tip of the 10 pin electrode, a plasma chamber for confining a glow discharge plasma, and an electrically-insulating body that comprises an inner bore extending along the longitudinal axis from a bore entrance to a bore exit. The second end of the pin electrode comprises a discharge tip. The pin electrode penetrates the inner bore from the bore entrance and extends at least partly through the inner bore and a15 radial wall of a portion of the inner bore located between the second end of the pin electrode and the opposing electrode, is radially delimiting the plasma chamber. The plasma reactor is further configured for varying an electrode separation distance between the discharge tip of the pin electrode and the opposing electrode.

### FIELD OF THE DISCLOSURE

The present disclosure relates to a plasma reactor for plasma-based gas conversion, more specifically a plasma reactor that is suitable for greenhouse gas conversion such as carbon dioxide and methane gases.

### BACKGROUND

In view of the climate change and the global warming, the conversion of greenhouse gasses into valuable products has become a major subject in energy and environmental research.

An example of a conversion process with large potential that has been proposed is the combined conversion of CO₂ and CH₄ into syngas, namely CO and H₂. This process is also known as dry reforming of methane, DRM, and the reaction can be summarized as follows:

CO₂ (g)+CH₄ (g) [symbol] 2CO (g)+2H₂ (g)

The produced syngas can be used as building blocks for several value-added chemicals, including methanol and long-chain hydrocarbons through the Fischer-Tropsch process.

However, the dry reforming reaction is highly endothermic and hence must be carried out at high temperatures, which can lead to excessive energy consumption and operational costs. In addition, classical DRM devices suffer from catalyst deactivation, and so far this has severely limited large scale industrial implementation of DRM.

Plasma reactors provide for an alternative way for the conversion of greenhouse gasses and plasma reactors could thereby also make use of the DRM reaction.

Different types of plasma reactors exist for the purpose of plasma-assisted gas conversion. Plasma reactors can differ in design, geometry, and/or mode of operation, depending on the particular application for which the plasma reactor is used.

US2012024718 describes an apparatus for synergistically combining a plasma with a comminution means such as a fluid kinetic energy mill (jet mill), preferably in a single reactor and/or in a single process step.

US2007267289 describes a hydrogen gas production including supplying a hydrocarbon fluid to a gap between a pair of electrodes, applying a voltage across the electrodes to induce an electrical arc, wherein the electrical arc contacts the hydrocarbon to form a plasma and produces a gaseous product comprising hydrogen gas and a solid product comprising carbon, and dynamically adjusting the gap length to control at least one parameter of the plasma.

US2004033177 describes a plasma-based fuel reformer in which a fuel/air mixture is subjected to conditions including an electrical plasma arc that reforms the fuel air mixture into a hydrogen-rich gas.

Not all plasma reactors are however suitable for the performance of DRM.

While it is generally known in the art that gliding arc reactors, GA, provide some of the best conversion results for various applications, their use for dry reforming has problems owing to the reduced discharge stability when using high CH₄ fractions, due to the high electrical conductivity of CH₄ under arc discharge conditions.

Hence for the plasma reactor technology to become commercially attractive for large scale applications, especially for the processing of greenhouse gasses, further improvements are still desirable. What is important is to obtain a high conversion yield while minimizing energy consumption.

Hence there is room for improving plasma reactors for gas conversion.

### SUMMARY

It is an object of the present disclosure to provide a plasma reactor for plasma-based gas conversion, more specifically for greenhouse gas conversion wherein optimum use can be made of CO₂ and CH₄ reforming. It is further object to provide for a robust plasma reactor that is not suffering from the drawbacks discussed above of for instance a gliding arc plasma reactor when used for DRM.

The inventors found that the close geometry between the pin electrode and the inner bore results in a wall-stabilization effect which contributes to the generation of a stable glow discharge plasma in the plasma chamber.

The present invention is defined in the appended independent claims. The dependent claims define advantageous embodiments.

According to a first aspect of the present disclosure, a plasma reactor for plasma-based gas conversion is provided. The plasma reactor is a reactor that is suitable to generate a glow discharge plasma.

The plasma reactor comprises a pin electrode extending along a longitudinal axis from a first end to a second end, and wherein the second end comprises a discharge tip, an opposing electrode opposing the discharge tip of the pin electrode, a plasma chamber between the second end of the pin electrode and the opposing electrode, and an electrically-insulating body that comprises an inner bore extending along the longitudinal axis from a bore entrance to a bore exit. The plasma reactor according to the present disclosure is characterized in that the pin electrode penetrates the inner bore from the bore entrance and extends at least partly through the inner bore, and in that a radial wall of a portion of the inner bore located between the second end of the pin electrode and the opposing electrode, is radially delimiting the plasma chamber. Further, the plasma reactor is configured for varying an electrode separation distance between the discharge tip of the pin electrode and the opposing electrode.

The term “radial wall” refers to the wall of the inner bore, wherein the radial wall delimits the inner bore. For example, if the inner bore is of a cylindrical shape, the radial wall is the wall defining this shape, and therefor the radial wall itself is of a cylindrical shape.

Advantageously, with the geometry of the plasma reactor comprising an electrically-insulating body, i.e. a body made of non-conductive material, and wherein an inner bore is forming a plasma chamber between a discharge tip of a pin electrode and an opposing electrode, a glow discharge plasma can be generated by first initiating the plasma discharge at low voltage, e.g. below 10 kV, by reducing the electrode separation distance and then increasing the electrode separation distance while increasing the electrical power supplied to the plasma chamber. With the compact geometry wherein the pin electrode is inserted inside the bore of the body and wherein the bore is forming the plasma chamber, the generated plasma is confined and touches the walls of the plasma chamber which results in a flattening of the temperature gradient of the plasma. This leads to a homogenous and stable glow discharge within a confined plasma chamber.

In this way, by introducing for example carbon dioxide and methane as feed gas, optimum use can be made of the DRM reaction. With the present plasma reactor, the formation of soot or other by products is reduced and problems related to plasma instabilities as is the case with the GA plasma reactor are limited.

When applying for instance methane dry reforming with the plasma reactor according to the present disclosure, the fact that the electrode separation distance can be made longer, has also an effect on the stability of the plasma. When at shorter distances, with CH₄ mixtures, the plasma electrical conductivity is very high and therefore cannot maintain a sufficient voltage drop. Elongating the discharge by varying the electrode separation distance as presently claimed can increase the voltage drop and improve the stability of the plasma.

Advantageously, the variation of the electrode separation distance between the discharge tip of the pin electrode and the opposing electrode, allows for designing a compact reactor as the electrical insulation requirements are strongly reduced due to the fact that the stable glow plasma discharge can be initiated at a short distance using a low voltage, e.g. below 10 kV.

Following ignition of the discharge plasma, the electrode separation distance can be increased, which extends the length of the plasma chamber and associated glow discharge plasma. As a result a stable glow discharge plasma can be created over an extended length. As the plasma volume is larger, an increased production yield can be obtained.

Advantageously, plasma related parameters can be monitored and the separation distance can be adjusted to obtain an optimum conversion performance.

In embodiments, the opposing electrode is coupled to the bore exit of the inner bore.

In embodiments, the plasma reactor comprises a gas-sealing bearing coupled to the electrically-insulating body. The gas-sealing bearing, preferably a linear gas-sealing bearing is configured for enabling the pin electrode to move through the inner bore for varying the electrode separation distance while the inner bore remains airtightly sealed off. Preferably the gas-sealing bearing is coupled to the bore entrance of the inner bore.

The plasma reactor according to the present disclosure can advantageously be used for converting CO₂ and CH₄ greenhouse gasses into syngas, through the DRM reaction. In addition, the plasma reactor is to be used for CO₂ splitting into CO and O₂.

According to a second aspect of the present disclosure, a method is provided for operating the plasma reactor disclosed in claim 1 and for performing plasma-based gas conversion with a glow-discharge plasma. The method is disclosed in the appended claims.

### SHORT DESCRIPTION OF THE DRAWINGS

These and further aspects of the present disclosure will be explained in greater detail by way of example and with reference to the accompanying drawings in which:

FIG. 1 schematically illustrates a cross-section of a plasma reactor according to the present disclosure,

FIG. 2 illustrates a perspective view of a plasma reactor according to the present disclosure,

FIG. 3 schematically illustrates a perspective view of the inside of the plasma reactor shown on FIG. 2,

FIG. 4a and FIG. 4b are cross-sections of the plasma reactor shown on FIG. 2 wherein the separation distance between the pin electrode and the opposite electrode is set at respectively a first distance ES1 and a second distance ES2,

FIG. 5 schematically illustrates an embodiment of a plasma reactor according to the present disclosure comprising a drive mechanism and a controller,

FIG. 6 schematically illustrates a cross-section of an embodiment of a plasma reactor according to the present disclosure comprising an afterglow chamber,

FIG. 7 shows a side view of the plasma reactor of FIG. 6,

FIG. 8 shows a more detailed view of the plasma reactor shown in FIG. 6,

FIG. 9 illustrates a perspective view of an embodiment of a plasma reactor according to the present disclosure being horizontally positioned with respect to a floor level.

The drawings of the figures are neither drawn to scale nor proportioned. Generally, identical components are denoted by the same reference numerals in the figures.

### DETAILED DESCRIPTION OF EMBODIMENTS

The present disclosure will be described in terms of specific embodiments, which are illustrative of the disclosure and not to be construed as limiting. It will be appreciated by persons skilled in the art that the present disclosure is not limited by what has been particularly shown and/or described and that alternatives or modified embodiments could be developed in the light of the overall teaching of this disclosure. The drawings described are only schematic and are non-limiting.

Use of the verb “to comprise”, as well as the respective conjugations, does not exclude the presence of elements other than those stated. Use of the article “a”, “an” or “the” preceding an element does not exclude the presence of a plurality of such elements.

Furthermore, the terms first, second and the like in the description and in the claims, are used for distinguishing between similar elements and not necessarily for describing a sequence, either temporally, spatially, in ranking or in any other manner. It is to be understood that the terms so used are interchangeable under appropriate circumstances and that the embodiments of the disclosure described herein are capable of operation in other sequences than described or illustrated herein.

Reference throughout this specification to “one embodiment” or “an embodiment” means that a particular feature, structure or characteristic described in connection with the embodiments is included in one or more embodiment of the present disclosure. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one ordinary skill in the art from this disclosure, in one or more embodiments.

### Plasma Reactor

Various types of plasma reactors for performing plasma-based gas conversion exist in the art. The plasma reactor according to the present disclosure is designed for efficient and stable operation in a glow discharge regime, which is generally characterized by lower plasma temperatures when compared to the arc discharge regime. More specifically, the plasma reactor according to the present disclosure is designed to generate a stable glow discharge plasma for obtaining a high gas conversion performance, for instance for the conversion of greenhouse gases. As discussed above, a reaction of particular interest is the DRM process for converting at the same time carbon dioxide and methane. Although the plasma reactor according to the present disclosure is particularly suited for operating in a glow discharge regime, depending on particular operational settings, e.g. power supply used, and gas flow regimes, the plasma reactor might also operate in an spark, arc or transitional discharge regime.

The plasma reactors according to the present disclosure are also named atmospheric pressure plasma reactors as they typically operate at atmospheric pressure, but in principle they can operate in a pressure range between a few mbar to a few bar. For plasma reactors limited for operation in a glow discharge regime, these plasma reactors are also named atmospheric pressure glow discharge plasma reactors, APGD.

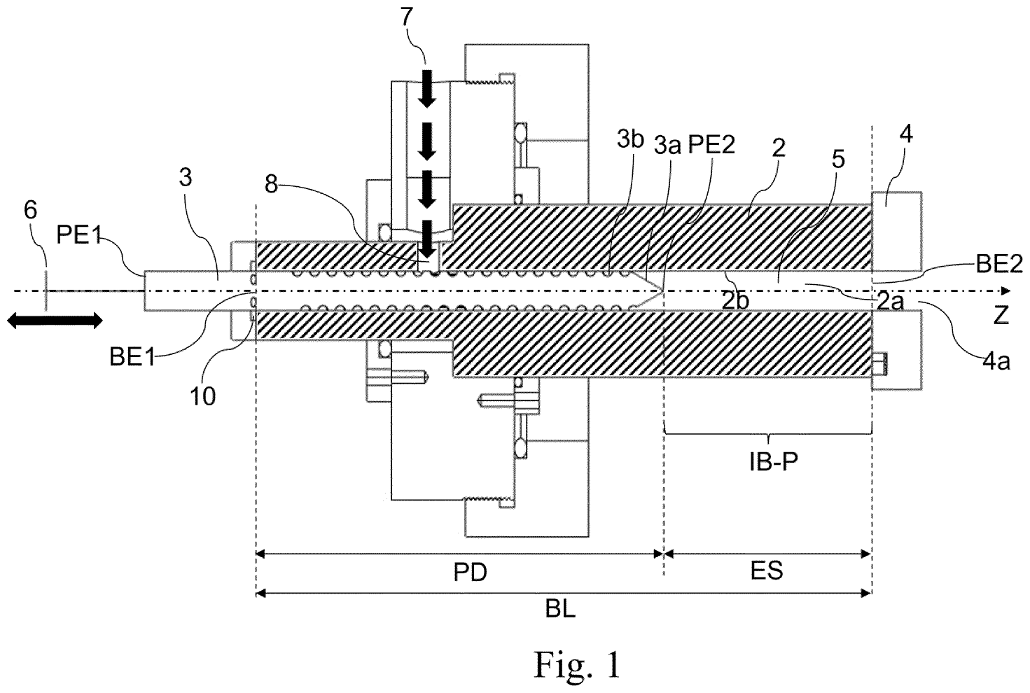

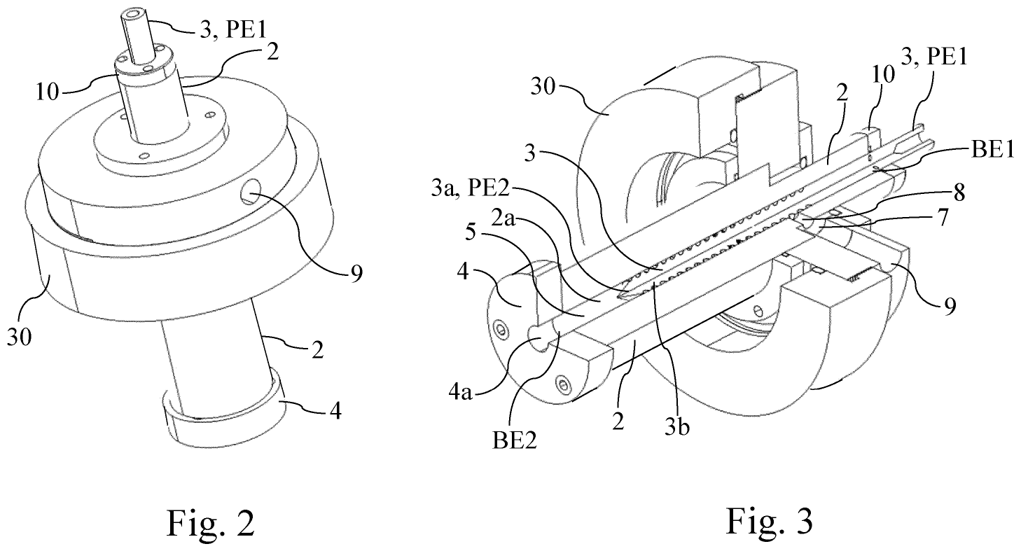

With reference to FIG. 1 to FIG. 9, various views of embodiments of the plasma reactor 1 or parts of the plasma reactor 1 according to the present disclosure are shown.

The plasma reactor 1 for plasma-based gas conversion according to the present disclosure comprises an electrode pair wherein a first electrode is a pin electrode 3 extending along a longitudinal axis Z from a first end PE1 to a second end PE2, and an opposing electrode opposing the pin electrode 3. The pin electrode comprises a discharge tip 3a at the second end PE2. In embodiments, the discharge tip 3a or at least the top of the discharge tip can have a conical shape.

The plasma chamber 5 that is confining the plasma is between the pin electrode, more specifically the second end PE2 of the pin electrode 3, and the opposing electrode 4.

In embodiments, as for example schematically illustrated on FIG. 1, the opposing electrode 4 has the shape of a plate and wherein the plate comprises a central opening 4a. The central opening 4a allows for evacuating converted and unconverted feed gas from the plasma chamber 5.

In embodiments, the pin electrode and the opposing electrode are for example made of stainless steel or other conductive materials, such as copper, aluminum and precious metals, but also carbon.

The plasma reactor further comprises an electrically-insulating body 2, i.e. a body made of a non-conducting material. The electrically-insulating body 2 comprises an inner bore 2a extending along the longitudinal axis Z from a bore entrance BE1 to a bore exit BE2. The electrically-insulating body can for example be made of a material of any of the following list of electrically insulating materials: ceramic, glass, alumina, zirconia, plastic, wood or natural stone, or a combination thereof. When the body is made of a ceramic material, the ceramic material is preferably a high-temperature resistant ceramic.

In embodiments, the electrically-insulating body 2 is manufactured as a single body.

A material of particular interest is a machinable ceramic, for example the ceramic known under the brand name Macor® With this material, the electrically-insulating body 2 can be machined, e.g. by drilling and milling, from a block of ceramic. In this way, a robust and custom made electrically-insulating body 2 forming a single body is obtained.

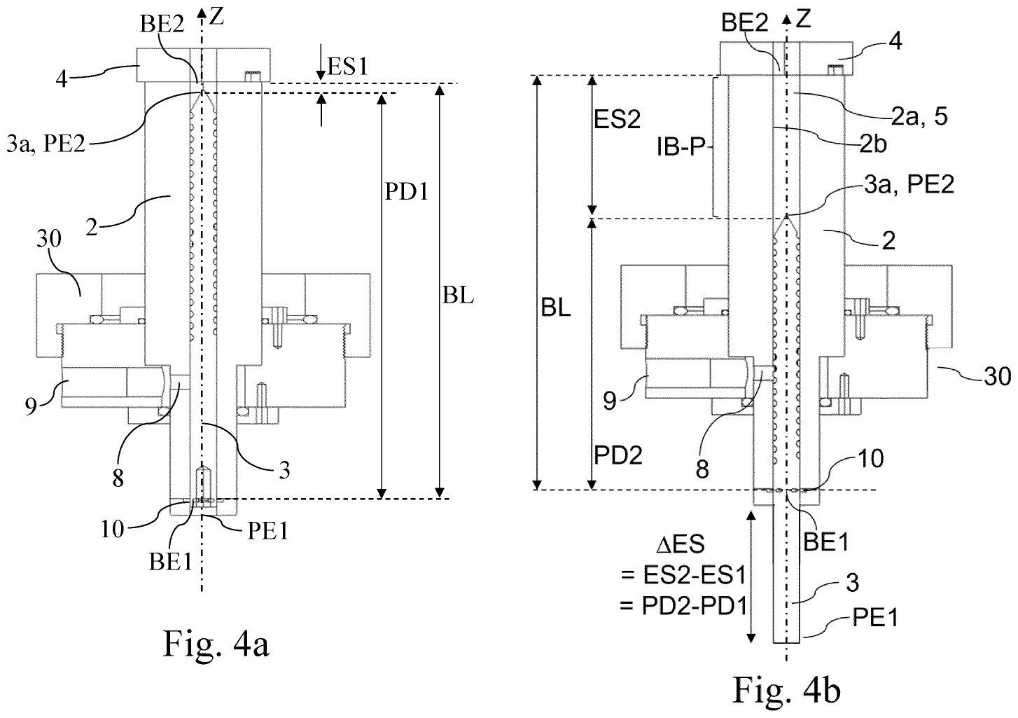

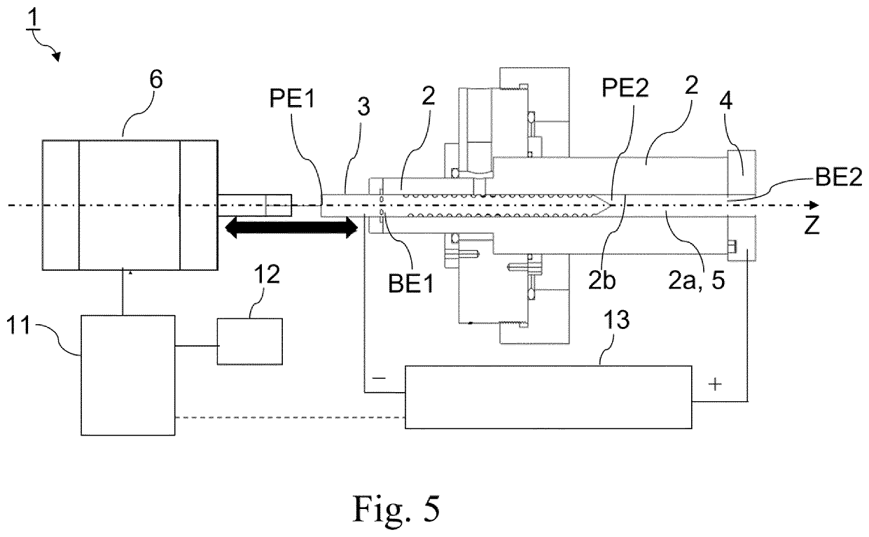

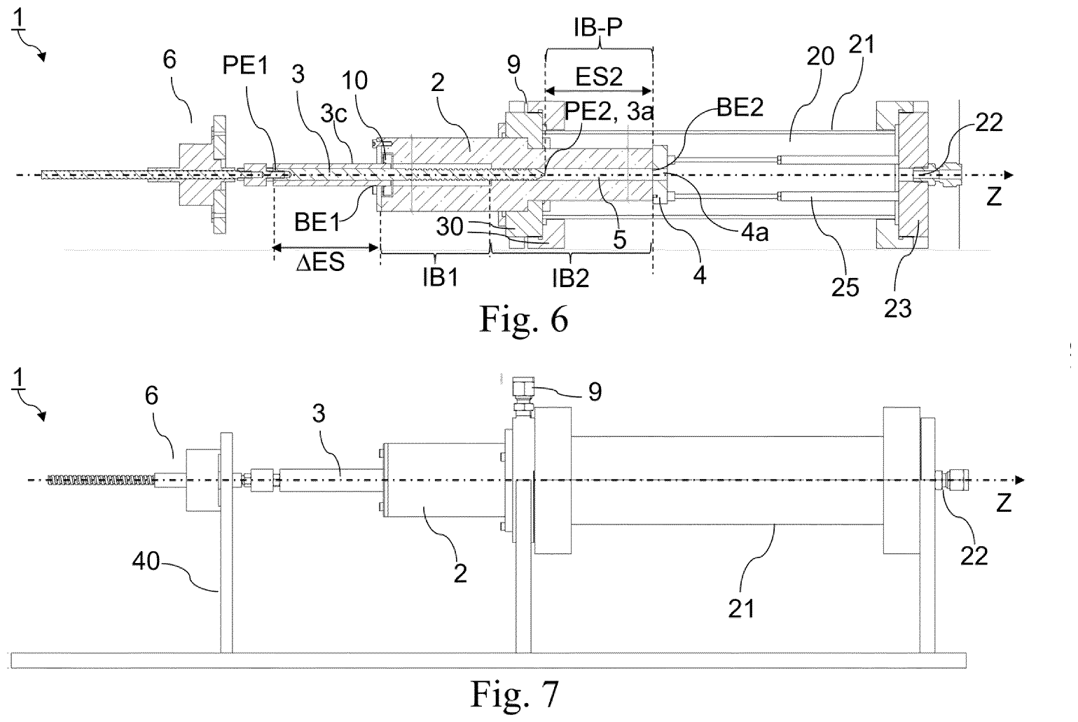

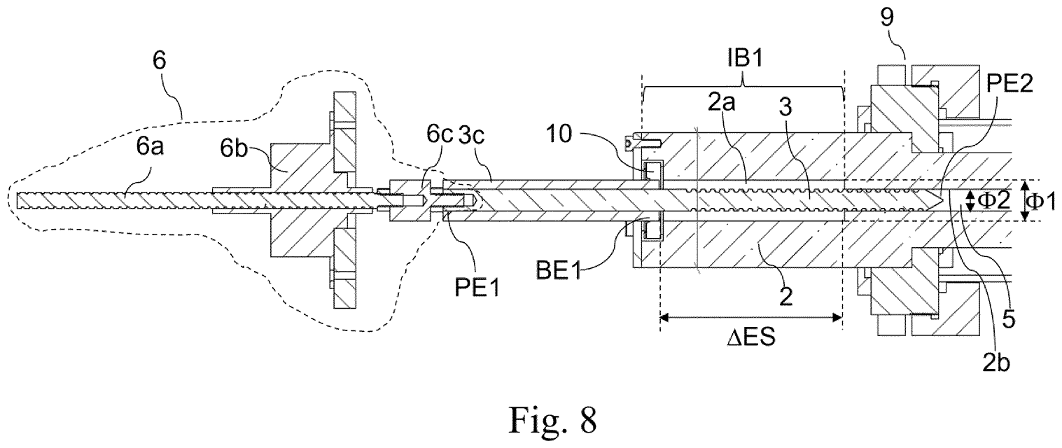

As illustrated on FIG. 1, FIG. 3, FIG. 4a, FIG. 4b, FIG. 5, FIG. 6 and FIG. 8, the pin electrode 3 penetrates the inner bore 2a from the bore entrance BE1 and then further extends, at least partly, through the inner bore. The plasma chamber 5, as indicated on FIG. 1 and FIG. 6, is formed by a portion IB-P of the inner bore that is located between the second end of the pin electrode 3 and the opposing electrode. More specifically a radial wall 2b of the portion IB-P of the inner bore 2a between the second end of the pin electrode and the opposing electrode is radially delimiting the plasma chamber. The plasma chamber 5 is an area wherein the plasma is confined and the radial inner wall 2b of the inner bore portion IB-P that is radially delimiting the plasma chamber 5 is contributing to the creation of a stable glow discharge plasma due to the effect of wall-stabilization, as mentioned above.

The plasma reactor according to the present disclosure is configured for varying an electrode separation distance ES between the discharge tip 3a of the pin electrode 3 and the opposing electrode 4. As a consequence, the length along the longitudinal axis Z of the plasma chamber 5, is variable and hence when the plasma reactor is in operation, the longitudinal extension of the generated plasma can be controlled.

Typically the electrode separation distance ES is variable between a first ES1 and a second ES2 separation distance, as respectively shown in FIG. 4a and FIG. 4b. In FIG. 4a, the electrode separation distance is at a minimum value ES1, while in FIG. 4b, the electrode separation distance is at a maximum value ES2.

Generally, the first separation distance ES1 is equal or smaller than 10 mm, preferably equal or smaller than 5 mm, more preferably equal or smaller than 2 mm, and the second separation distance ES2 is equal or larger than 15 mm, preferably equal or larger than 20 mm, more preferably equal or larger than 30 mm. The first short separation distance ES1 allows to ignite a glow discharge plasma at low voltages, e.g. at a voltage equal or below 10 KV and the second separation distance ES2 is then used to increase the length of the plasma chamber and hence elongate the plasma volume so as to increase the conversion performance.

In the embodiments shown on FIG. 1 to FIG. 9, a penetration depth PD of the pin electrode 3 into the inner bore 2a is variable while the opposing electrode 4 remains stationary positioned with respect to the body 2. Herein the opposing electrode 4 is stationary positioned with respect to the body 2. In this way, a variation of the penetration depth PD causes a variation of the electrode separation distance ES. In these embodiments, the opposing electrode 4 is for example coupled to the bore exit BE2.

For the embodiments wherein the pin electrode can be moved along the longitudinal axis Z, the stroke ΔES of the pin electrode defining the maximum variation of the electrode separation distance is schematically illustrated on FIG. 4b and is equal to ES2 minus ES1, with ES2 and ES1 being respectively the maximum and minimum electrode separation distance.

In other embodiments, the opposing electrode 4 is axially moveable through the inner bore along the longitudinal axis so as to vary the electrode separation distance ES. In these embodiments, the pin electrode remains stationary with respect to the electrically-insulating body. Herein the pin electrode 3 is stationary positioned with respect to the body 2. The movement of the opposing electrode can for example be performed by an actuator or magnets positioned around the plasma reactor can be used to induce a movement of the opposing electrode.

In embodiments wherein the pin electrode can penetrate through the inner bore of the insulating body 2 for varying the electrode separation distance, the plasma reactor comprises a gas-sealing bearing 10 coupled to the body 2 and configured for enabling the pin electrode 3 to sealingly move through the inner bore 2a. In this way, the inner bore 2a remains airtightly sealed off while moving the pin electrode 3 through the inner bore 2a. Preferably the gas-sealing bearing 10 is coupled to the bore entrance BE1 of the inner bore. The gas-sealing bearing allows for a free motion of the pin electrode along the longitudinal axis Z while maintaining the bore entrance BE1 sealed, i.e. airtight.

In embodiments, the gas-sealing bearing is a linear bearing allowing a translation motion of the pin electrode along the longitudinal axis Z. The linear bearing can also be construed as a sliding contact or sliding bearing.

In other embodiments the gas-sealing bearing is a gas-sealing rotor bearing allowing a rotational motion of the pin electrode for moving the pin electrode along the longitudinal axis.

Typically, the gas-sealing bearing 10 comprises a central hole having an inner seal for sealingly receiving the pin electrode through the hole. The seal is configured such that even when moving the pin electrode along the longitudinal axis the inner bore remains sealed off from the outside of the plasma reactor and for example no feed gas can escape from the inner bore through the bore entrance BE1.

In the embodiments shown on FIG. 1 to FIG. 9, the inner bore of the body 2 has a bore length BL measured along the longitudinal axis from the bore entrance BE1 to the bore exit BE2 and wherein 2.0×ΔES≤BL≤4.0×ΔES, preferably 2.2×ΔES≤BL≤3.5×ΔES, more preferably 2.3×ΔES≤BL≤3.0×ΔES, and wherein ΔES corresponds to a maximum variation of the electrode separation distance. In other words, the body 2 has been made longer when compared to a plasma reactor that has a fixed electrode separation distance and where generally the length of the insulating body or the length of the inner bore is equal or close to the fixed electrode separation distance. By making the length of the inner bore two times or more than two times longer than the maximum electrode separation distance ΔES a robust plasma reactor is designed wherein the risks of internal or external sparks or unwanted discharges, independent of the electrode separation distance that is set between the minimum and maximum electrode separation distance, are strongly reduced. To keep the overall dimensions of the plasma reactor compact, the bore length BL is limited to a maximum that is lower than for example three or four times the maximum electrode separation distance.

In embodiments as illustrated on FIG. 6 and FIG. 8, a portion of the pin electrode 3 is surrounded by a circumferential insulator 3c. In these embodiments, the inner bore comprises a first bore portion IB1 starting at the bore entrance BE1 that has a cross-sectional area ϕ1 that is larger than a cross-sectional area ϕ2 of a second bore portion IB2, adjacent to the first bore portion IB1. These cross-sectional areas are for instance taken in a plane perpendicular to the longitudinal axis Z, and wherein the cross-sectional area ϕ1 of the first bore portion IB1 is configured such that the portion of the pin electrode 3 that is surrounded by the circumferential insulator 3c is receivable within the first bore portion IB1 of the inner bore.

In this way, by surrounding a portion of the pin electrode with a circumferential insulator 3c as illustrated on FIG. 6 and FIG. 8, when the pin penetration depth inside the inner bore is reduced and hence the pin electrode sticks out of the body 2, the part of the pin electrode that sticks out of the body 2 remains well insulated from the other parts of the plasma reactor which improves the robustness of the plasma reactor against external sparks.

Preferably, the first bore portion IB1 having cross-sectional area ϕ1 has a length measured along the longitudinal axis that is equal or larger than a maximum variation of the electrode separation distance ΔES.

In embodiments, as illustrated on FIG. 6 and FIG. 8, the portion of the pin electrode 3 that is surrounded by a circumferential insulator 3c is a portion that starts at the first end PE1 of the pin electrode, opposite the second end PE2 of the pin electrode comprising the discharge tip.

Generally, the plasma reactor according to the present disclosure comprising a drive mechanism 6 for varying the electrode separation distance ES.

In embodiments, as schematically shown on FIG. 5 to FIG. 8, the drive mechanism 6 is coupled to the first end PE1 of the pin electrode 3 and configured for axially moving the pin electrode 3 through the inner bore along the longitudinal axis Z.

In embodiments, as shown in more detail on FIG. 8, the drive mechanism to drive the pin electrode is for example a motorized linear actuator 6 comprising a shaft 6a linearly moveable along the longitudinal axis with respect to a stationary block 6b, and a coupling element 6c coupling the shaft 6a of the linear actuator with the first end PE1 of the pin electrode 3. The linear actuator 6 is configured for moving the pin electrode over a stroke ΔES corresponding to the difference between the maximum ES2 and minimum ES1 electrode separation distance.

The drive mechanism of the plasma reactor is however not limited to a linear actuator, any other suitable drive mechanism for driving the linear motion of the pin electrode can be conceived by the person skilled in the art. The drive mechanism 6 comprises for example any of: a motorized linear actuator, a manual crank, a pneumatic pusher, or a motion actuator based on a heat-expandable material.

In embodiments, as schematically illustrated on FIG. 5, the plasma reactor comprises a monitoring device 12 for monitoring one or more plasma related variables when the plasma reactor is in operation. The plasma related variables are for example any of: a discharge current, a temperature, a gas production yield, a gas flow rate or a combination thereof. The plasma reactor further comprises a controller 11 for controlling the drive mechanism, and wherein the controller is configured to vary the electrode separation distance ES as function of the one or more plasma related variables. In this way, during operation of the plasma reactor, an optimum conversion performance can be maintained.

The plasma reactor further comprises a gas supply 9 for supplying a feed gas towards the plasma chamber. When the plasma reactor is in operation the gas supply is coupled with a gas supply system for continuously supplying feed gas to the plasma reactor.

In embodiments, as for instance illustrated on FIG. 3, which is showing a portion of the inside of the plasma reactor, the electrically-insulating body 2 comprises a gas passage 8 extending through the body 2 from a gas entrance 7 at an outer side of the body 2 to a gas exit that opens into the inner bore. The gas supply 9 is fluidly coupled with the gas entrance 7 of the body such that feed gas can be supplied from the outside of the body 2 to the inner bore of the body.

In embodiments, the gas passage 8 is a radial gas passage radially crossing the electrically-insulating body 2.

In embodiments, the inner bore of the body 2 has a cylindrical shape and

the pin electrode has a corresponding matching cylindrical shape. In other embodiments, the inner bore and the pin electrode can have a different shape such as the shape of a cuboid.

In embodiments, the plasma chamber has a cylindrical shape and the inner diameter ϕ2 of the radial wall 2b of the portion IB-P of the inner bore 2a that is radially delimiting the plasma chamber 5, illustrated for example on FIG. 8, is between 4 mm and 20 mm, preferably between 5 mm and 15 mm, more preferably between 5 mm and 12 mm.

In embodiments, the electrically-insulating body has a cylindrical shape and the outer diameter is for example between 30 mm and 50 mm.

The pin electrode and the inner bore are dimensioned such that the circumference of the pin electrode closely matches the circumference of the inner bore, or at least the circumference of that part of the inner bore that is forming the plasma chamber.

In embodiments, the matching of the circumference of the inner bore and the outer circumference of the pin electrode can be expressed as follows: 0.70<S1/S2<1, preferably 0.80<S1/S2<1, more preferably 0.85<S1/S2<1, with S1 being a cross-sectional area of the pin electrode and S2 being a cross-sectional area of the plasma chamber, and wherein the cross-sectional areas are taken in a plane perpendicular to the longitudinal axis Z. The matching coefficient will depend on the materials of use, i.e. higher thermal expansion coefficient would require greater tolerance. For embodiments wherein the inner bore has a cylindrical shape, the cross-sectional area S2 is circular and hence S2=π×ϕ2×ϕ2/4, with ϕ2 being the inner diameter of the radial wall 2b of the portion IB-P of the inner bore 2a that is radially delimiting the plasma chamber 5, as shown on FIG. 8. For embodiments wherein the pin electrode also has a cylindrical shape, the cross-sectional area S1 can be expressed as S1=π×(ϕ2−Δϕ)×(ϕ2−Δϕ)/4, with Δϕ being a diameter reduction of the pin electrode when compared to the diameter of the inner bore, to allow for a minimum spacing between the pin electrode and the inner bore to facilitate the movement of the pin electrode through the inner bore.

Due to the close matching of the pin electrode inside the inner bore, no or very few gas can be transported from the gas exit of the gas passage 8 to the plasma chamber 5. Therefore one or more dedicated gas transport means are provided.

In embodiments, the pin electrode 3 comprises a groove 3b or a channel configured for facilitating a flow of the feed gas inside the inner bore from the gas exit of the gas passage 8 towards the plasma chamber 5. The groove 3b or channel can for instance be made, e.g. through machining of the pin electrode, on the outer circumferential surface of the pin electrode. For example a groove of about one mm deep can be made. In other embodiments, axial channels can be made through the pin electrode to facilitate a flow of the feed gas inside the inner bore from the gas exit of the gas passage 8 towards the plasma chamber 5.

In embodiments, the groove 3b has a spiral shape. In other embodiments, this groove is linear, or alternately, it can be a central bore in the pin electrode 3. In embodiments, there may be two, three or more grooves in parallel.

Advantageously, the feed gas flowing through the grooves or channels of the pin electrode is cooling the pin electrode. In this way, in embodiments, no additional cooling means are required and a compact plasma reactor can be conceived.

When the plasma reactor is in operation, the feed gas is generally supplied at high pressure, i.e. at a pressure above one bar. For example, when the plasma reactor is in operation, the pressure inside the gas passage 8 of the electrically-insulating body 2 is between 2 bar and 10 bar. Generally, the pressure in the plasma chamber 5 is at a pressure between for example 1 bar and 2 bar.

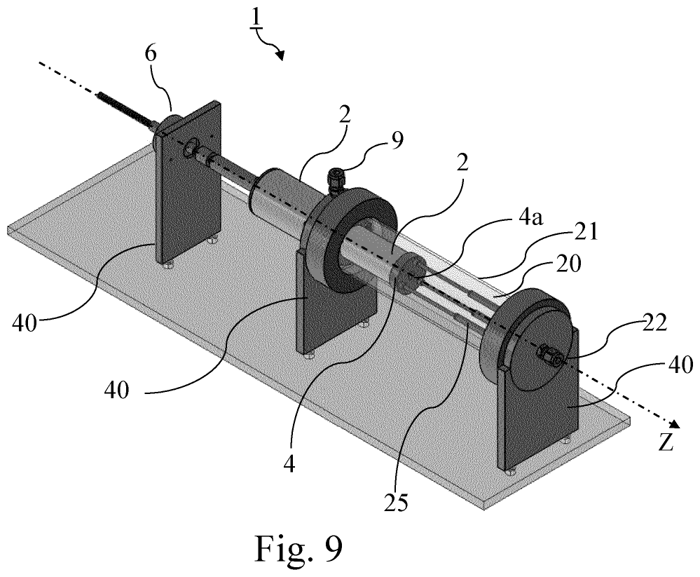

In embodiments, as illustrated on FIG. 6, FIG. 7 and FIG. 9, the plasma reactor comprises an afterglow chamber 20 configured for receiving converted and unconverted feed gas exiting the central opening 4a of the opposing electrode. Generally, when the plasma reactor is in operation, a plasma afterglow is axially generated that extends in the afterglow chamber 20. The plasma afterglow can further contribute to the gas conversion.

In the embodiment shown on FIG. 6 and FIG. 9, the afterglow chamber 20 is radially delimited by a radial wall 21 that can for example be made from an insulating material such as quartz. The afterglow chamber 20 further comprises an axial flange 23 having a central opening that forms an exit 22 for evacuating converted and unconverted feed gas from the afterglow chamber. Axial bars 25, illustrated on FIG. 6 and FIG. 9, axially extending from the axial flange 23 of the afterglow chamber are connected to the opposing electrode 4. The axial bars 25, preferably metallic bars, form in this way a supporting structure for supporting the opposing electrode 4 and also form an electrical connection to the opposing electrode, that generally is to be grounded.

In embodiments, the afterglow chamber 20 is coupled to the plasma chamber. In embodiments, as illustrated on FIG. 6, the afterglow chamber 20 has an inner diameter that is larger than the outer diameter of the electrically-insulating body 2 and the radial wall 21 of the afterglow chamber partly circumscribes the plasma chamber 5. This allows to attach the afterglow chamber 20 to the coupling structure 30 as illustrated on FIG. 6.

The plasma reactor according to the present disclosure can for example be mounted in a horizontal position, i.e, wherein the longitudinal axis is horizontal with respect to a floor level, as illustrated on FIG. 9. A support structure 40 is configured for supporting the plasma reactor and maintaining the plasma reactor in a horizontal position with respect to the floor level.

The plasma reactor according to the present disclosure comprises a power supply 13 for powering the plasma reactor, as schematically illustrated on FIG. 5. The power supply 13 is for example a DC power supply. In embodiments, an output current of the power supply is limited to a maximum current value, and wherein the maximum current value is between 10 mA and 500 mA, preferably between 20 mA and 60 mA, more preferably between 30 mA and 50 mA. In this way, the plasma formed in the plasma chamber is maintained in glow discharge plasma regime.

Typically, the power supply uses a ballast resistor, for example of 300 kΩ, to limit the output current of the power supply. Alternatively, the power supply can be configured to operate as a current source, which negates the need for a resistor.

In embodiments, the power supply 13 is configured for supplying a maximum output voltage of 20 kV, preferably 15 kV, more preferably 10 kV. As discussed above, due to the variation of the electrode separation distance a smaller-sized power supply of for example 10 KV can be used, as the plasma can be initiated by reducing the electrode separation distance in a first step and then afterwards in a second step increase the electrode separation distance while maintaining the plasma reactor operating in a glow discharge plasma regime.

Typically, the pin electrode 3 is a cathode pin and the opposing electrode is the anode electrode. The cathode is generally negatively biased while the anode is grounded.

The plasma reactor according to the present disclosure can advantageously be used for converting CO₂ and CH₄ greenhouse gasses into syngas, i.e. CO and H₂, through the dry reforming of methane (DRM) reaction corresponding to:

CO₂ (g)+CH₄ (g) [symbol] 2CO (g)+2H₂ (g)

### Method for Operating the Plasma Reactor

According to a second aspect of the present disclosure, a method for operating the plasma reactor discussed above is disclosed. The method comprises steps of:
setting the electrode separation distance to a first separation distance (ES1), and wherein the first separation distance (ES1) is equal or smaller than 10 mm, preferably equal or smaller than 5 mm, more preferably equal or smaller than 2 mm,
supplying a feed gas into the plasma chamber,
generating a glow-discharge plasma by:
setting a high-voltage between the pin electrode and the opposing electrode, and wherein the high-voltage is maximum 20 kV, preferably maximum 15 kV, more preferably maximum 10 kV,
and limiting an electrical discharge current between the pin electrode and the opposing electrode to a maximum current value, and wherein the maximum current value is 60 mA, preferably 40 mA, more preferably 30 mA,
following an ignition of a plasma when at the first electrode distance ES1, and while continuing supplying power to the plasma reactor for maintaining the plasma, varying the relative position between the discharge tip of the pin electrode and the opposing electrode until a second separation distance ES2 is obtained, and wherein the second separation distance is larger than the first separation distance, and wherein a difference ΔES between the second separation distance ES2 and the first separation distance ES1 is equal or larger than 10 mm, preferably equal or larger than 15 mm, more preferably equal or larger than 25 mm,
extracting converted and unconverted feed gas from the plasma chamber.

As discussed above, advantageously a smaller power supply operating at a lower high-voltage can be used with the method according to the present disclosure. For instance, by initially setting the first electrode distance to a small distance, e.g. 5 mm or less, a power supply operating at a maximum voltage as low as 10 KV can be used to initiate the plasma, e.g. a glow discharge plasma. By further increasing the electrode distance to a second electrode distance, larger than the first electrode distance, and while limiting the discharge current to a maximum value, e.g. below 40 mA, a glow-discharge plasma can be maintained that is elongating while increasing the electrode separation distance. In view of the close geometry between the pin electrode and the inner bore, a wall-stabilization effect contributes to the generation of a stable glow discharge plasma over an extended length defined by the second electrode separation distance.

In embodiments, the method step of supplying feed gas comprises supplying CO₂ and wherein the plasma converts the CO₂ feed gas into CO and O₂.

In further embodiments, the method step of supplying feed gas comprises at least supplying a mixture of CO₂ and CH₄ gasses.

### Detailed Characterizations

Here below, text is provided in the form of clauses. The clauses comprise characterizations indicating a variety of options, features, and feature combinations that can be used in accord with the teachings of the present disclosure. Alternate characterizations of the ones given, but consistent with the descriptions herein above, are possible In summary, according to the present disclosure, the following list of clauses could for instance be claimed:
1. A plasma reactor 1 for plasma-based gas conversion comprising:
   a pin electrode 3 extending along a longitudinal axis Z from a first end (PE1) to a second end PE2, and wherein the second end comprises a discharge tip 3a,
   an opposing electrode 4 opposing the discharge tip 3a of the pin electrode,
   a plasma chamber 5 between said second end PE2 of the pin electrode 3 and said opposing electrode 4,
   an electrically-insulating body 2 comprising an inner bore 2a extending along said longitudinal axis Z from a bore entrance BE1 to a bore exit BE2,
characterized in that the pin electrode 3 penetrates said inner bore from the bore entrance BE1 and extends at least partly through said inner bore,
and in that a radial wall 2b of a portion IB-P of the inner bore between the second end PE2 of the pin electrode 3 and the opposing electrode 4, is radially delimiting said plasma chamber 5,
and in that said plasma reactor is configured for varying an electrode separation distance ES between the discharge tip 3a of the pin electrode 3 and the opposing electrode 4.
2. The plasma reactor according to clause 1 wherein a penetration depth PD of the pin electrode 3 into said inner bore is variable while said opposing electrode 4 is stationary positioned with respect to said electrically-insulating body 2 such that a variation of said penetration depth PD causes a variation of said electrode separation distance ES.
3. The plasma reactor according to clause 2 wherein said opposing electrode 4 is coupled to said bore exit BE2.
4. The plasma reactor according to any of previous clauses comprising a gas-sealing bearing 10 coupled to the electrically-insulating body 2 and configured for enabling the pin electrode to move through the inner bore for varying said electrode separation distance ES while the inner bore remains airtightly sealed off, preferably said gas-sealing bearing 10 is coupled to the bore entrance BE1 of the inner bore.
5. The plasma reactor according to clause 4 wherein said gas-sealing bearing 10 is coupled to the bore entrance BE1 of the inner bore.
6. The plasma reactor according to clause 4 wherein said gas-sealing bearing is a linear gas-sealing bearing.
7. The plasma reactor according to any of previous clauses wherein said inner bore 2a has a bore length BL measured along the longitudinal axis from the bore entrance BE1 to the bore exit BE2 and wherein 2.0×ΔES≤BL≤4.0×ΔES, preferably 2.2×ΔES≤BL≤3.5×ΔES, more preferably 2.3×ΔES≤BL≤3.0×ΔES, and wherein ΔES corresponds to a maximum variation of said electrode separation distance.
8. The plasma reactor according to any of previous clauses wherein a portion of said pin electrode 3 is surrounded by a circumferential insulator 3c, and wherein said inner bore 2a comprises a first bore portion IB1 starting at said bore entrance BE1 that has a cross-sectional area ϕ1 that is larger than a cross-sectional area ϕ2 of a second bore portion IB2, adjacent to the first bore portion IB1, and wherein the cross-sectional area of the first bore portion IB1 is configured such that the portion of the pin electrode 3 that is surrounded by the circumferential insulator 3c is receivable within the first bore portion IB1 of the inner bore, preferably the cross-sectional areas ϕ1, ϕ2 are taken in a plane perpendicular to the longitudinal axis Z.
9. The plasma reactor according to clause 8 wherein a length of said first bore portion IB1 measured along the longitudinal axis Z is equal or larger than a maximum variation of the electrode separation distance ΔES.
10. The plasma reactor according to clause 1 wherein the opposing electrode 4 is axially moveable through said inner bore along said longitudinal axis so as to vary said electrode separation distance ES.
11. The plasma reactor according to any of previous clauses comprising a drive mechanism 6 for varying said electrode separation distance.
12. The plasma reactor according to clause 11 wherein said drive mechanism 6 comprises any of: a motorized linear actuator, a manual crank, a pneumatic pusher, or a motion actuator based on a heat-expandable material.
13. The plasma reactor according to clause 11 or clause 12 wherein said drive mechanism 6 is coupled to the first end PE1 of the pin electrode 3 and configured for axially moving the pin electrode 3 through said inner bore along said longitudinal axis Z.
14. The plasma reactor according to any of clauses 11 to 13 comprising:
   a monitoring device 12 for monitoring one or more plasma related variables and wherein the plasma related variables are any of: a discharge current, a temperature, a gas production yield, a gas flow rate or a combination thereof,
   a controller 11 for controlling said drive mechanism, and wherein said controller is configured to vary said electrode separation distance ES as function of the one or more plasma related variables.
15. The plasma reactor according to any of previous clauses wherein the electrode separation distance ES is variable between a first ES1 and a second ES2 separation distance, and wherein the first separation distance ES1 is equal or smaller than 10 mm, preferably equal or smaller than 5 mm, more preferably equal or smaller than 2 mm, and the second separation distance ES2 is equal or larger than 15 mm, preferably equal or larger than 20 mm, more preferably equal or larger than 30 mm.
16. The plasma reactor according to any of previous clauses wherein 0.70<S1/S2<1, preferably 0.80<S1/S2<1, more preferably 0.85<S1/S2<1, with S1 being a cross-sectional area of the pin electrode and S2 being a cross-sectional area of the plasma chamber, and wherein said cross-sectional areas are taken in a plane perpendicular to the longitudinal axis Z.
17. The plasma reactor according to any of previous clauses wherein said inner bore has a cylindrical shape and/or said pin electrode 3 has a cylindrical shape.
18. The plasma reactor according to any of previous clauses wherein the plasma chamber 5 has a cylindrical shape and wherein an inner diameter ϕ2 of the radial wall 2b of the portion IB-P of the inner bore 2a that is radially delimiting the plasma chamber 5 is between 4 mm and 20 mm, preferably between 5 mm and 15 mm, more preferably between 5 mm and 12 mm.
19. The plasma reactor according to any of previous clauses wherein at least a top portion of said discharge tip 3a of the pin electrode 3 has the shape of a cone.
20. The plasma reactor according to any of previous clauses wherein said electrically-insulating body 2 is made of a material of any of: ceramic, glass, alumina, zirconia, plastic, wood or natural stone, or a combination thereof.
21. The plasma reactor according to any of previous clauses comprising a gas supply 9 for supplying a feed gas.
22. The plasma reactor according to clause 21 wherein the electrically-insulating body 2 comprises a gas passage 8 extending through said electrically-insulating body 2 from a gas entrance at an outer side of the electrically-insulating body 2 to a gas exit that opens into the inner bore, and wherein said gas supply 9 is fluidly connected with said gas entrance 7 of the electrically-insulating body 2 such that feed gas can be supplied from the outside of the electrically-insulating body 2 to the inner bore of the electrically-insulating body.
23. The plasma reactor according to clause 22 wherein the pin electrode 3 comprises a groove 3b or a channel configured for facilitating a flow of the feed gas inside the inner bore from the gas exit of the gas passage 8 towards the plasma chamber 5.
24. The plasma reactor according to any of previous clauses wherein said opposing electrode 4 has the shape of a plate and wherein the plate comprises a central opening 4a for evacuating converted and unconverted feed gas from the plasma chamber 5.
25. The plasma reactor according to clause 24 comprising an afterglow chamber 20 configured for receiving converted and unconverted feed gas exiting the central opening 4a of the opposing electrode.
26. The plasma reactor according to any of previous clauses comprising a power supply 13 for powering the plasma reactor.
27. The plasma reactor according to clause 26 wherein an output current of said power supply 13 is limited to a maximum current value, and wherein said maximum current value is between 10 mA and 500 mA, preferably between 20 mA and 60 mA, more preferably between 30 mA and 50 mA.
28. The plasma reactor according to clause 26 or clause 27 wherein said power supply 13 is configured for supplying a maximum output voltage of 20 KV, preferably 15 kV, more preferably 10 kV.
29. Use of a plasma reactor according to any of previous clauses for converting CO₂ and CH₄ into syngas, through the following reaction:

CO₂ (g)+CH₄ (g) [symbol] 2CO (g)+2H₂ (g)
30. Use of a plasma reactor according to any of clauses 1 to 28 for converting CO₂ into CO and O₂.
31. A method for operating the plasma reactor according to any of clauses 1 to 28 for performing plasma-based gas conversion, the method comprising:
   setting the electrode separation distance to a first separation distance ES1, and wherein said first separation distance ES1 is equal or smaller than 10 mm, preferably equal or smaller than 5 mm, more preferably equal or smaller than 2 mm,
   supplying a feed gas into the plasma chamber,
   generating a glow-discharge plasma by: setting a high-voltage between the pin electrode and the opposing electrode, and wherein said high-voltage is maximum 20 kV, preferably maximum 15 kV, more preferably maximum 10 KV, and limiting an electrical discharge current between the pin electrode and the opposing electrode to a maximum current value, and wherein said maximum current value is 60 mA, preferably 40 mA, more preferably 30 mA,
   following an ignition of a plasma at said first electrode distance ES1, and while continuing supplying power to the plasma reactor for maintaining the plasma, varying the relative position between the discharge tip of the pin electrode and the opposing electrode until a second separation distance ES2 is obtained, and wherein said second separation distance is larger than the first separation distance, and wherein a difference ΔES between the second separation distance ES2 and the first separation distance ES1 is equal or larger than 10 mm, preferably equal or larger than 15 mm, more preferably equal or larger than 25 mm,
   extracting converted and unconverted feed gas from the plasma chamber.
32. The method of clause 31 wherein the feed gas comprises CO₂.
33. The method of clause 31 wherein the feed gas comprises at least a mixture of CO₂ and CH₄ gasses.

### REFERENCE NUMBERS

| | |
|---|---|
| 1 | Plasma reactor |
| 2 | Electrically-Insulating body |
| 2a | Inner bore |
| 2b | Radial wall of inner bore |
| 3 | Pin electrode |
| 3a | Discharge tip |
| 3b | groove |
| 3c | pin insulator |
| 4 | Opposing electrode |
| 4a | Central opening |
| 5 | Plasma chamber |
| 6 | Drive mechanism |
| 7 | Gas entrance of electrically insulating body |
| 8 | Gas passage |
| 9 | Gas supply |
| 10 | Gas-sealing bearing |
| 11 | controller |
| 12 | Monitoring device |
| 13 | Power supply |
| 20 | afterglow chamber |
| 21 | Radial wall of afterglow chamber |
| 22 | Exit of afterglow chamber |
| 23 | Axial flange of afterglow chamber |
| 25 | Axial bars |
| 30 | coupling structure |
| 40 | Supporting structure |
| BE1 | First bore entrance |
| BE2 | Second bore exit |
| PE1 | First end of electrode pin |
| PE2 | Second end electrode pin |

1. A plasma reactor for plasma-based gas conversion comprising:
a pin electrode extending along a longitudinal axis from a first end to a second end, and wherein the second end comprises a discharge tip,
an opposing electrode opposing the discharge tip of the pin electrode,
a plasma chamber between said second end of the pin electrode and said opposing electrode,
an electrically-insulating body comprising an inner bore extending along said longitudinal axis from a bore entrance to a bore exit, wherein the inner bore of the electrically-insulating body has a cylindrical shape and the pin electrode has a corresponding matching cylindrical shape, and wherein the opposing electrode is coupled to the bore exit of the inner bore,
characterized in that the pin electrode penetrates said inner bore from the bore entrance and extends at least partly through said inner bore,
and in that a radial wall of a portion of the inner bore between the second end of the pin electrode and the opposing electrode, is radially delimiting said plasma chamber,
and in that said plasma reactor is configured for varying an electrode separation distance between the discharge tip of the pin electrode and the opposing electrode.

2. The plasma reactor according to claim 1, wherein a penetration depth of the pin electrode into said inner bore is variable while said opposing electrode is stationary positioned with respect to said electrically-insulating body such that a variation of said penetration depth causes a variation of said electrode separation distance.

3. The plasma reactor according to claim 1, further comprising a gas-sealing bearing coupled to the electrically-insulating body and configured for enabling the pin electrode to move through the inner bore for varying said electrode separation distance while the inner bore remains airtightly sealed off.

4. The plasma reactor according to claim 1, wherein said inner bore has a bore length BL measured along the longitudinal axis from the bore entrance to the bore exit and wherein 2.0×ΔES≤BL≤4.0×ΔES, and wherein ΔES corresponds to a maximum variation of said electrode separation distance.

5. The plasma reactor according to claim 1, wherein a portion of said pin electrode is surrounded by a circumferential insulator, and wherein said inner bore comprises a first bore portion starting at said bore entrance that has a cross-sectional area that is larger than a cross-sectional area of a second bore portion, adjacent to the first bore portion, and wherein the cross-sectional area of the first bore portion is configured such that the portion of the pin electrode that is surrounded by the circumferential insulator is receivable within the first bore portion of the inner bore.

6. The plasma reactor according to claim 1, wherein the opposing electrode is axially moveable through said inner bore along said longitudinal axis so as to vary said electrode separation distance.

7. The plasma reactor according to claim 1, further comprising a drive mechanism for varying said electrode separation distance, said drive mechanism comprising any of: a motorized linear actuator, a manual crank, a pneumatic pusher, or a motion actuator based on a heat-expandable material.

8. The plasma reactor according to claim 7 comprising:
a monitoring device for monitoring one or more plasma related variables and wherein the one or more plasma related variables are any of: a discharge current, a temperature, a gas production yield, a gas flow rate or a combination thereof,
a controller for controlling said drive mechanism, and wherein said controller is configured to vary said electrode separation distance as function of the one or more plasma related variables.

9. The plasma reactor according to claim 1, wherein the electrode separation distance is variable between a first separation distance and a second separation distance, and wherein the first separation distance is equal to or smaller than 10 mm, and the second separation distance is equal to or larger than 15 mm.

10. The plasma reactor according to claim 1, wherein 0.70<S1/S2<1, with S1 being a cross-sectional area of the pin electrode and S2 being a cross-sectional area of the plasma chamber, and wherein said cross-sectional areas are taken in a plane perpendicular to the longitudinal axis.

11. The plasma reactor according to claim 1, wherein the plasma chamber has a cylindrical shape and wherein an inner diameter of the radial wall of the portion of the inner bore that is radially delimiting the plasma chamber is between 4 mm and 20 mm.

12. The plasma reactor according to claim 1, further comprising a gas supply for supplying a feed gas, and wherein the electrically-insulating body comprises a gas passage extending through said electrically-insulating body from a gas entrance at an outer side of the electrically-insulating body to a gas exit that opens into the inner bore, and wherein said gas supply is fluidly connected with said gas entrance of the electrically-insulating body such that feed gas can be supplied from an outside of the electrically-insulating body to the inner bore of the electrically-insulating body.

13. The plasma reactor according to claim 12, wherein the pin electrode comprises a groove or a channel configured for facilitating a flow of the feed gas inside the inner bore from the gas exit of the gas passage towards the plasma chamber.

14. The plasma reactor according to claim 1, wherein said opposing electrode has the shape of a plate and wherein the plate comprises a central opening for evacuating converted and unconverted feed gas from the plasma chamber.

15. A method for operating the plasma reactor according to claim 1, for performing plasma-based gas conversion, the method comprising:
setting the electrode separation distance to a first separation distance, and wherein said first separation distance is equal to or smaller than 10 mm,
supplying a feed gas into the plasma chamber,
generating a glow-discharge plasma by:
setting a high-voltage between the pin electrode and the opposing electrode, and wherein said high-voltage is maximum 20 kV, and limiting an electrical discharge current between the pin electrode and the opposing electrode to a maximum current value, and wherein said maximum current value is 60 mA,
following an ignition of a plasma at said first separation distance, and while continuing supplying power to the plasma reactor for maintaining the plasma, varying a relative position between the discharge tip of the pin electrode and the opposing electrode until a second separation distance is obtained, and wherein said second separation distance is larger than the first separation distance, and wherein a difference between the second separation distance and the first separation distance is equal to or larger than 10 mm,
extracting converted and unconverted feed gas from the plasma chamber.
